(19) United States
(12) Patent Application Publication
(10) Pub. No.: US 2026/0249732 A1
(43) Pub. Date: Aug. 27, 2026

(54) ELECTRIC VEHICLE CHARGING MANAGEMENT

(71) Applicant: Eaton Intelligent Power Limited, Dublin (IE)

(72) Inventors: Manoj DAS, Jamshedpur (IN); Manishkumar SHARMA, Pune (IN); Amit KUMAR, Pune (IN); Nirmal THOLE, Pune (IN); Kamlesh JAIN, Udaipur (IN)

(21) Appl. No.: 19/552,101

(22) Filed: Feb. 27, 2026

(30) Foreign Application Priority Data
Feb. 27, 2025 (IN) IN 2025110172213

(51) Int. Cl. B60L 53/63; B60L 53/30; B60L 53/62; B60L 53/68; H02J 3/17; B60L 53/64

(52) U.S. Cl. CPC B60L 53/63; B60L 53/305; B60L 53/62; B60L 53/68; H02J 3/17; B60L 53/64

(57) ABSTRACT

A load control receiver includes a utility connection, a charging connection, and a relay controlling the supply of power from the utility connection to the charging connection. The load control receiver can be controlled in response to periods of low or high demand to control the availability and/or speed of charging based on demand response signals. A notification system can provide invitations to charge during periods of low demand, and the load control receivers can offer subsidized energy at particular times to users based on such invitations.

### BACKGROUND

Electric power demand can vary significantly over the course of a day. Charging of electric vehicles can be energy intensive, and unplanned charging, particularly at or near peak demand times, can cause stress to the power grid, can lead to voltage imbalances in the grid, can cause misalignment of demand with the availability of renewable energy, and can contribute to brownouts or blackouts due to peak demand meeting or exceeding grid capacity.

### SUMMARY

Embodiments of the present disclosure can control loads associated with electric vehicle charging using a load control receiver provided in the electric vehicle charger or between the grid connection and the charger. The load control receiver can control access to charging and charging speed based on the demand on the power grid. Controlling the charging in response to grid demand can improve grid stability and reduce or avoid brownout or blackout conditions and improve management of unplanned demand spikes associated with electric vehicle charging.

In an embodiment, the load control receiver can include or be connected to a notification system alerting users regarding charging opportunities during periods of relatively lower demand. Charging during the periods of lower demand can enable greater use of fast charging and reduce costs for charging while allowing grid owners to manage demand, reducing peak demand, making demand more predictable and consistent, and improving utilization of grid resources.

In an embodiment, a load control receiver for an electric vehicle charging system includes a utility power connection configured to receive power, a charging connection configured to supply power to an electric vehicle charger, a relay configured to control supply of power to the charging connection, a wireless communication modem, and a controller configured to receive a demand response signal by way of the wireless communication modem and control the relay to control a quantity of power supplied to the charging connection based on the demand response signal.

In an embodiment, a method for controlling electric vehicle charging includes determining a demand condition based on a demand for power for a utility grid and when the demand condition exceeds a threshold, issuing a demand response signal to a plurality of load control receivers connected to the grid. One or more load control receivers of the plurality of load control receivers control a respective relay to reduce a quantity of power provided to a respective electric vehicle charger connected to said load control receiver based on receiving the demand response signal.

In an embodiment, a system for controlling electrical vehicle charging includes a plurality of charging systems and a utility enterprise system configured to determine a demand condition for a utility grid and based on the demand condition, issue a demand response signal to the plurality of charging systems. Each of the plurality of charging systems includes a utility power connection configured to receive power from the utility grid, a charging connection configured to supply power to an electric vehicle charger, a relay configured to control supply of power to the charging connection and a controller configured to receive the demand response signal and control the relay based on the demand response signal.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 shows a schematic of a charging system according to an example embodiment.

FIG. 2 shows a method of controlling a charging system according to an example embodiment.

FIG. 3 shows a method of alerting users regarding charging opportunities at a charging system.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

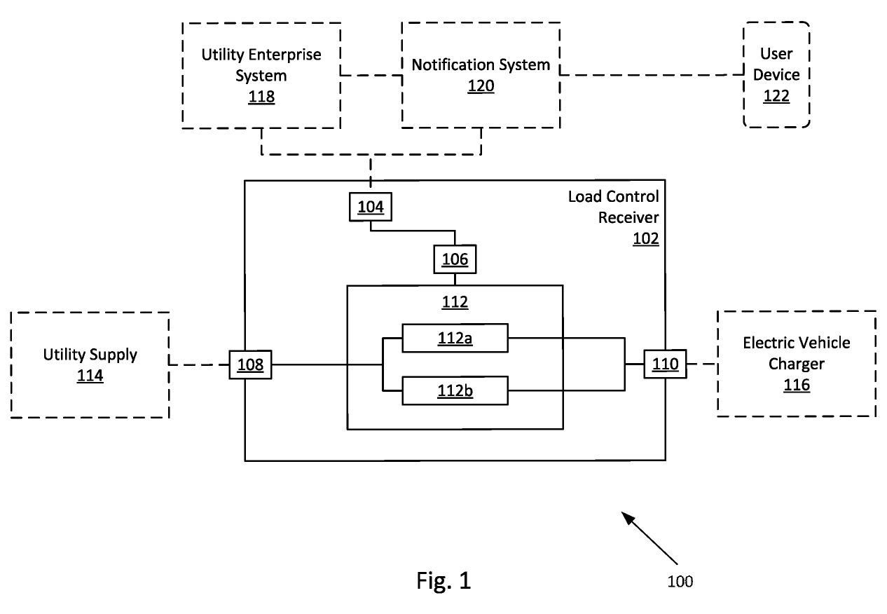

FIG. 1 shows a schematic of a charging system according to an example embodiment. Charging system 100 includes load control receiver 102. Load control receiver 102 includes wireless communications modem 104, controller 106, utility connection 108, charger connection 110, and relay 112. The utility connection 108 can be connected to a utility supply 114. The charger connection 110 can be connected to one or more electric vehicle chargers 116. Utility enterprise system 118 can interface with charging system 100. In an embodiment, utility enterprise system 118 can include or interface with a notification system 120. The notification system 120 can provide notifications to user devices 122.

Charging system 100 manages charging of one or more electric vehicles. The one or more electric vehicles can include a personal electric vehicle, electric vehicles using commercial chargers, electric vehicles of a fleet of electric vehicles, or the like. The charging system 100 can be managed by a utility to control demand and/or utilization of the utility. Charging system 100 can be implemented using load control receivers 102 located between utility supplies 114 and respective electric vehicle chargers 116. Charging system 100 can be responsive to periods of high and/or low demand, for example to control loading of the utility when at or near peak conditions by slowing or limiting charging of electric vehicles, and/or to encourage electric vehicle charging at periods of low demand to raise utilization of available power during such periods.

Load control receiver 102 is configured to control the charging of electric vehicles so as to manage electricity demand. Load control receiver 102 is located between the utility supply 114 and one or more electric vehicle chargers 116, controlling the supply of power to the one or more electric vehicle chargers 116. Load control receiver 102 can be configured to switch the one or more electric vehicle chargers 116 from standard to fast charging or vice versa, and/or to disconnect the one or more electric vehicle chargers 116 such that no power is provided to the one or more electric vehicle chargers 116.

Wireless communications modem 104 is provided to allow load control receiver 102 to receive signals such as a demand response signal from a utility enterprise system 118, a definition of a charging opportunity assigned to a corresponding user by notification system 120, or the like. In an embodiment, wireless communications modem 104 can be configured to allow over-the-air firmware updates for the load control receiver 102. The wireless communications modem 104 can be configured to use one or more wireless communications standards, such as Wi-Fi, BlueTooth, cellular data connections such as 4G, 5G, LTE, or the like, such that the load control receiver can connect to the internet directly or through one or more other devices (i.e. routers, devices having wired internet connections, etc.). The wireless communications modem 104 can be configured to allow the load control receiver 102 to upload data, for example to provide collected data such as energy usage or charging session details to utility enterprise system 118 or another suitable recipient of such data.

Controller 106 is configured to control the load control receiver in response to demand response signals received by way of the wireless communications modem 104. The controller 106 can be configured to reduce the power supplied to the electric vehicle chargers 116 through the load control receiver 102 by controlling the relay 112. For example, controller 106 can direct the relay 112 to reduce the current supplied to the charger connection 110, thereby reducing a charging speed. In an embodiment, the controller 106 can direct the relay 112 to reduce the charging speed of electric vehicle chargers 116 from a fast charging operation to standard charging operations. In an embodiment, the controller 106 can direct the relay 112 to interrupt the supply of power to the charger connection 110, deactivating the electric vehicle chargers 116. In an embodiment, the controller 106 can be configured to direct the load control receiver to supply power to electric vehicle chargers 116 during defined times such as during a charging opportunity that a user has been invited to by the notification system 120.

In an embodiment, the control exercised by controller 106 can be further based on a user of the load control receiver 102 opting into or out of at least some demand response options. For example, a user can opt out of the load control receiver reducing power in response to the demand response signal. Such a user may pay higher time-of-use rates and/or penalties while continuing to charge a connected electric vehicle at the respective electric vehicle charger 116. In another example, a user can opt into reduction of charging speed but opt out of disconnection of the charger. In yet another example, a user can opt into continuing charging once a charging opportunity has passed or opt into ceasing charging once the charging opportunity has passed and energy is no longer being subsidized. Opt-in or opt-out status of the user can be stored in a local memory included in controller 106 in an embodiment. In alternative embodiments, opt-in or opt-out status can be stored in a memory included in utility enterprise system 118, notification system 120, cloud storage, or another such remote memory. In an embodiment, opt-in or opt-out statuses can be selected by the user through a user interface of the load control receiver 102, a mobile application, a website, or the like.

In an embodiment, controller 106 can collect data regarding energy usage or associated data. For example, controller 106 can keep a running total of energy usage, times during which power is supplied to the electric vehicle chargers 116, total costs of energy consumed by the electric vehicle chargers, or the like. In an embodiment, controller 106 can collect energy usage or associated data for a particular charging sessions, such as energy usage, duration to complete a charging operations, costs during a particular charging opportunity during a low demand period, or the like. In an embodiment, costs during a particular charging opportunity where subsidized energy is available can be compared to standard rates by the controller 106, utility enterprise system 118, and/or notification system 120 to determine a cost savings associated with charging using the subsidized energy during the charging opportunity.

Utility connection 108 is configured to receive power from a utility such as utility supply 114. Utility supply 114 is a supply of power from a utility, such as a service connection. Charger connection 110 is configured to supply power to one or more electric vehicle chargers 116. Charger connection 110 can receive power metered by the relay 112. Charger connection 110 can be any suitable connection from which the electric vehicle charger 116 can draw power. Relay 112 is configured to control the supply of power received at the utility connection 108 to the charger connection 110. Relay 112 can be configured to supply suitable power for standard or fast charging, such as providing suitable current ratings for the type of charging, or to interrupt the supply of power to the charger connection 110. Relay 112 can include one or more solid state relays configured to dynamically control the level of power supplied to the charger connection 110. Relay 112 can be controlled by the controller 106, such that the controller 106 can dictate whether relay 112 is supplying current supporting fast charging, standard charging, or stopping the supply of power, for example to reduce the supply of power to reduce charging speed or stop charging in response to a demand response signal being received at the controller 106. In an embodiment, relay 112 can include a high current relay 112a and a low current relay 112b. The high current relay 112a, when connected, can provide power supporting fast charging of an electric vehicle connected to the electric vehicle charger 116 receiving power from charger connection 110. The low current relay 112b, when connected, can provide power supporting standard or slow charging of an electric vehicle connected to the electric vehicle charger 116 receiving power from charger connection 110. The supply of power can also be stopped by relay 112 when both high current relay 112a and low current relay 112b are in an open or disconnected position.

Electric vehicle chargers 116 are one or more chargers for electric vehicles connected to the load control receiver at charger connection 110. Electric vehicle chargers 116 can include any suitable chargers for electric vehicles. In an embodiment, the electric vehicle chargers 116 can include one or more of a fast charger (for example, a 100-350 amp charger, a DC fast charger, or the like), a standard charger (for example, a level 1 (12-16 amp) or level 2 (16-40 amp) charger), combinations thereof, and the like. Non-limiting examples of electric vehicle chargers 116 include SAE J1772 chargers, Mennekes chargers, Combined Charging Systems (CCS), CHAdeMO chargers, GB/T chargers, and proprietary chargers for certain electric vehicle manufacturers.

Utility enterprise system 118 is a system executing enterprise software for an electrical utility supplier. The utility enterprise system 118 can determine demand on the utility, such as forecasts of demand, current demand including unexpected or unplanned demand on the utility, or the like. Utility enterprise system 118 can be configured to determine when demand is at or above a threshold level and/or to predict times when the demand may be at or above the threshold level. Based on demand meeting or exceeding the threshold level, a demand response signal can be generated and distributed to load control receivers 102. The demand response signal can be sent to particular load control receivers 102 based on the present or expected power draw of the specific load control receivers 102, an amount of load needing to be reduced to achieve desired demand levels, or the like. In an embodiment, the utility enterprise system 118 can determine when the demand on the utility is below a desired utilization value or predict when the demand can be below the desired utilization value. When the demand on the utility is below the desired utilization value, notification system 120 can provide charging opportunities to users to increase utilization of the utility during such off-peak periods. In an embodiment, a machine learning algorithm be used to predict demand. The machine learning algorithm can be trained using historical demand data for the utility, data on grid assets and/or loads, or any other suitable data. A non-limiting example of a utility enterprise system 118 is the Yukon software platform from Eaton Corp.

Notification system 120 can optionally be provided to determine charging opportunities and to assign the charging opportunities to at least some users of charging systems 100. The notification system 120 can be configured to determine a number of charging opportunities and to assign the charging opportunities to users associated with particular load control receivers 102. Notification system 120 can include a machine learning algorithm to support or perform the determination of charging opportunities and/or assignment of charging opportunities to users, for example to predict response rates to charging opportunities, predict expected loads from response to the charging opportunities, etc. The charging opportunities can be periods of time where consumption of energy is subsidized or otherwise promoted, for example through accrual of credits, rewards programs, or the like. The notification system can determine the number of charging opportunities based on the demand and the desired utilization value. Optionally, the number of charging opportunities can further be based on additional factors, for example rates at which such charging opportunities are utilized by candidate users, quantities of demand associated with charging by candidate users, or the like. In an embodiment, the number of charging opportunities can be selected such that an expected demand from users taking advantage of the charging opportunities brings utility demand to approximately the desired demand level for the utility. The candidate users can be some or all of the users of charging systems 100 associated with the utility. In an embodiment, users opt into or out of being candidate users for receiving charging opportunities from notification system 120. In an embodiment, such opt-in or opt-out status can be stored in a memory included in notification system 120. In an embodiment, individual users can be preferred over institutional users such as commercial chargers or fleet operators when determining the candidate users.

The notification system 120 can be configured to assign the charging opportunities to users from the pool of candidate users. In an embodiment, the selection of users to which charging opportunities are assigned is at least semi-random. In an embodiment, the selection of users to which charging opportunities are assigned is random. In an embodiment, the selection of users to which charging opportunities are assigned is based on weighted randomization, wherein the weighting is based on one or more characteristics of the user such as being an individual or institutional user, the expected demand from the user, the particular type of electric vehicle charger 116 associated with the user, an amperage associated with the electric vehicle charger 116 associated with the user, whether a charging time associated with the user fits within the duration of the charging opportunity, or the like.

The notification system 120 can issue notifications to users to which a charging opportunity has been assigned. The notification can be issued by the notification system 120 by, for example, providing a notification by text message such as SMS, providing a notification in a dedicated application such as a mobile app, through sending of an email, through display of the notification on a website accessed by the user, or the like. The notification provided by the notification system 120 can include at least the time window during which the charging opportunity is available to the user. The notification can include optional additional data, such as a charger or vehicle that the charging opportunity is available for, an incentive associated with the charging opportunity such as the extent of subsidy for the rate of power provided during the charging opportunity, or the like.

In an embodiment, notification system 120 can additionally or alternatively provide notifications to users when demand response signals are issued by a utility, or when the response of load control receiver 102 to such demand response signals reduces charging speed or interrupts charging of an electric vehicle connected to the electric vehicle charger 116 receiving power from charger connection 110.

In an embodiment, notification system 120 is integrated into utility enterprise system 118. In an embodiment, notification system 120 can be a separate system utility enterprise system 118 but interfacing with enterprise system 118, for example to receive demand data from the enterprise system 118.

User devices 122 are computing devices owned by users of the charging system 100, such as, as non-limiting examples, mobile phones, tablet computers, personal computers such as laptops or desktops, or the like. User devices 122 can be capable of receiving notifications from the notification system 120, for example by way of messaging protocols such as SMS or other text messaging, as notifications in a dedicated application such as a mobile app such as push notifications, through email, through access to a website, or the like. User devices 122 can include, as non-limiting examples, personal devices of individual users, one or more devices of an institutional user such as a fleet owner or an owner of a public or commercial electric vehicle charging infrastructure. In an embodiment, the user devices 122 can interface with the notification system to provide opt-in or opt-out status for one or more demand response behaviors of the charging system 100, for example opting into or out of slowing or stopping electrical vehicle charging during high demand periods or opting into or out of receiving notifications regarding charging opportunities, setting default behaviors regarding charging during or outside of the charging opportunities, and the like.

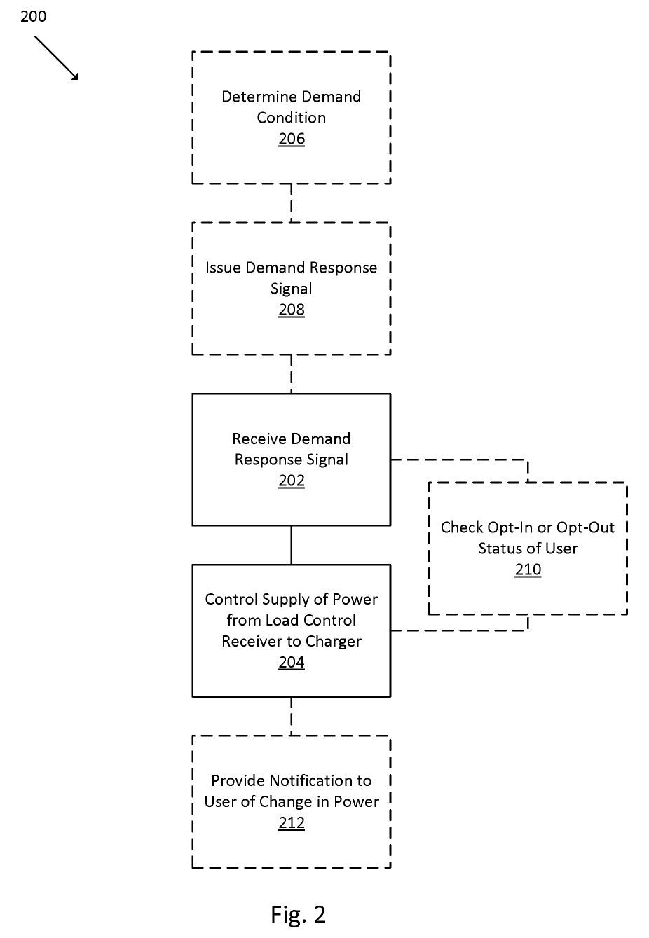

FIG. 2 shows a method of controlling a charging system according to an example embodiment. Method 200 includes receiving a demand response signal 202 at a load control receiver and controlling the supply of power from the load control receiver to a charger 204. Optionally, method 200 can further include determining a demand condition 206 and issuing the demand response signal 208. Optionally, method 200 can include checking an opt-in or opt-out status of a user at 210. Optionally, the method 200 can include notifying a user of a change in the supply of power from the load control receiver to the charger 212.

A demand response signal is received at 202. The demand response signal can be received from an enterprise system of an electrical utility. The demand response signal can indicate a need to reduce load on the electrical utility. The demand response signal received at 202 can be received through a wireless communication modem included in a load control receiver of the charging system.

The supply of power to a charger can be controlled using the load control receiver at 204. A controller of the load control receiver receiving the demand response signal can operate one or more relays thereof to reduce the power being provided to the charger, for example reducing the speed of charging provided by the charger or interrupting the supply of power to the charger, such that the demand on the utility resulting from charging of electric vehicles at the charger is reduced in response to the demand response signal.

Optionally, a demand condition can determined at 206 and the demand response signal can be issued at 208. The demand condition can be determined at 206 based on a detection of or prediction of demand on a utility grid. The detection or prediction of demand can be performed, for example, by a utility enterprise system, such as utility enterprise system 118 as discussed above and shown in FIG. 1. In an embodiment, a machine learning algorithm can be used to provide the detection or prediction of demand, for example following training based on historical demand data for the utility, data on grid assets and/or loads, or any other suitable data. The demand condition can be determined with respect to a desired utilization value, a maximum grid capacity, or the like. A demand response signal can be issued at 208 when the demand condition determined at 206 exceeds a corresponding threshold, for example indicating excessive demand compared to available utility power. The demand response signal can be issued at 208 by, for example, the utility enterprise system or a system directed by the utility enterprise system. The demand response signal issued at 208 can be the demand response signal received at the load control receiver at 202, causing the load control receiver to reduce the supply of power to the charger at 204.

Optionally, an opt-in or opt-out status of a user can be checked at 210. The opt-in or opt-out status of the user can be input by the user, for example through a user interface on the load control receiver, through a website, through a mobile application, or the like. The checking of the opt-in or opt-out status of the user at 210 can determine whether the user has opted into control of the charger in response to the demand response signal. Accordingly, in an embodiment where the opt-in or opt-out status of the user is checked at 210, the reduction in supply of power to the charger at 204 may occur only when the user has opted into, or when a user has not opted out of demand-based control of the charger, depending on whether or not participation in demand-based control is a default selection. In an embodiment, participation in demand-based control of the charger is a default and can be opted out of. In an embodiment, participation in demand-based control must be opted into by the user. In an embodiment, when users have opted out of or did not opt into demand-based control, charging following the demand response signal being issued at 208 can be subject to increased time-of-use rates, penalty rates, or the like.

Optionally, the method 200 can include notifying a user of a change in the supply of power from the load control receiver to the charger 212. The notification can be by, for example, text message such as SMS, providing a notification in a dedicated application such as a mobile app, through sending of an email, through display of the notification on a website accessed by the user, or the like. The notification can include, for example, the nature of the change being made such as slowing charging speed or interruption of charging, the load control receiver being affected, and other such information. The notification can be provided from a notification system such as notification system 120 described above and shown in FIG. 1, in communication with one or more of a utility enterprise system and/or the load control receiver.

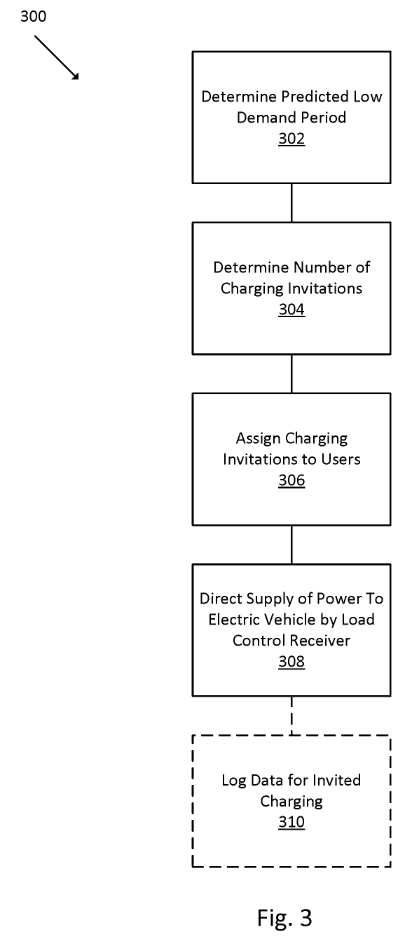

FIG. 3 shows a method of alerting users regarding charging opportunities at a charging system. Method 300 includes determining a predicted low demand period 302, determining a number of charging invitations to send 304, assigning the charging invitations to users at 306, and directing a load control receiver to supply power to an electric vehicle 308. Optionally, the method 300 can include logging data 310.

A low demand period is predicted at 302. The low demand period can be predicted, for example, by a utility enterprise system, such as utility enterprise system 118 as discussed above and shown in FIG. 1. The prediction of the low demand period at 302 can be based on historical demand data for the utility, data on grid assets and/or loads, time-of-use pricing for power from the utility, or any other suitable data. In an embodiment, a machine learning model trained on the historical demand data for the utility, data on grid assets and/or loads, time-of-use pricing history, combinations thereof, or the like can be used to predict the low demand period at 302. The low demand period is a period of time during which the utility is below a desired utilization level. In an embodiment, the low demand period must have a duration above a certain threshold to provide a charging opportunity for which charging invitations can be determined and assigned at 304 and 306, respectively. The threshold can be based on times to complete charging of electric vehicles using the utility.

A number of charging invitations can be determined at 304. The charging invitations can offer incentives such as a subsidized rate, rewards programs, or the like to induce a user to charge an electric vehicle during the predicted low demand period. The number of charging invitations can be determined based on, for example, expected capacity during the low demand period, a difference between the predicted demand during the low demand period and the desired utilization level, or the like. In an embodiment, the number of charging invitations determined at 304 can be further based on response rates of users to previous charging invitations. In an embodiment, a machine learning algorithm can be used to predict the number of invitations likely to bring utilization towards the desired utilization level. The machine learning algorithm can be trained based on historical data regarding user response rates, power consumption associated with electric vehicle chargers, and the like.

The charging invitations can be assigned to users at 306. The assignment of charging invitations can be to a defined pool of users, such as some or all users of chargers connected to load control receivers. The pool of users can, for example, include individual users, institutional users such as commercial chargers and/or fleet owners, combinations or subsets thereof, or the like. The assignment of charging invitations to users at 306 in the pool of users can be at least partially randomized. In an embodiment, the assignment of charging invitations to users at 306 in the pool of users is fully randomized. In an embodiment, the assignment of charging invitations to users at 306 in the pool of users can be weighted, for example based on one or more characteristics of the user such as being an individual or institutional user, the expected demand from the user, the particular type of electric vehicle charger associated with the user, characteristics of the electric vehicle charger associated with the user, such as an amperage or power draw of the charger, whether a charging time associated with the user fits within the duration of the charging opportunity, or the like.

Load control receivers can be directed to perform charging during the low demand period in accordance with the charging invitation at 308. In an embodiment, the load control receivers can automatically begin charging at the beginning of the low demand period and end charging at the end of the low demand period, thus only using subsidized energy or providing other incentives to the user. In an embodiment, charging during the low demand period at 308 can be part of a longer charging cycle for the electric vehicle, for example charging prior to or following the low demand period in addition to during the low demand period.

Data can be logged during the charging in accordance with a charging invitation at 310. The data logged at 310 can include, for example, acknowledgement that the charger was used during the low demand period, the amount of power consumed by the charger during the low demand period, a cost of the power consumed by the charger during the low demand period, or the like. The data logged at 310 can be provided to suitable systems such as a utility enterprise system, a notification system, or the like to inform future iterations of the method 300. In embodiments, the data logged at 310 can be used in training or updating machine learning models, including but not limited to machine learning models used for the prediction of low demand periods at 302, the determination of numbers of charging invitations at 304, and/or the assignment of the charging opportunities at 306.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A load control receiver for an electric vehicle charging system, comprising:
a utility power connection configured to receive power;
a charging connection configured to supply power to an electric vehicle charger;
a relay configured to control supply of power to the charging connection;
a wireless communication modem; and
a controller configured to receive a demand response signal by way of the wireless communication modem and control the relay to control a quantity of power supplied to the charging connection based on the demand response signal.

2. The load control receiver of claim 1, wherein the controller is further configured to receive a status of the load control receiver as being opted in to or opted out of demand response, and control the relay to reduce the quantity of power supplied to the charging connection when the status of the user is opted in to demand response.

3. The load control receiver of claim 2, wherein when the demand response signal is received and the status of the load control receiver is opted out of demand response, the controller controls the relay to supply power to the charging connection.

4. The load control receiver of claim 1, wherein the controller is configured to control the relay to reduce the quantity of power by interrupting power supplied to the charging station.

5. The load control receiver of claim 1, wherein the relay includes a high-current relay and a low-current relay.

6. The load control receiver of claim 5, wherein the controller controls the relay to reduce a quantity of power supplied to the charging connection by disconnecting the high-current relay.

7. A method for controlling electric vehicle charging, comprising:
determining a demand condition based on a demand for power for a utility grid;
when the demand condition exceeds a threshold, issuing a demand response signal to a plurality of load control receivers connected to the grid,
wherein one or more load control receivers of the plurality of load control receivers control a respective relay to reduce a quantity of power provided to a respective electric vehicle charger connected to said load control receiver based on receiving the demand response signal.

8. The method of claim 7, wherein the plurality of load control receivers being issued the demand response signal is determined based on present or expected power draw of load control receivers connected to the utility grid.

9. The method of claim 7, wherein the plurality of load control receivers being issued the demand response signal is determined based on a target amount of load reduction.

10. The method of claim 7, further comprising obtaining, for each of the plurality of load control receivers, a status as being opted in to or opted out of demand response, wherein load control receivers having a status of being opted in to demand response reduce the quantity of power provided to the respective electric vehicle charger.

11. The method of claim 10, wherein when the status of the load control receiver is opted out of demand response, the load control receiver supplies power to the respective electric vehicle charger.

12. The method of claim 11, wherein charging by a user opted out of the demand response is subject to an increased rate following the demand response signal.

13. The method of claim 7, further comprising notifying a user of a change in supply of power from one of the one or more load control receivers to the respective electric vehicle.

14. A system for controlling electrical vehicle charging, comprising:
a plurality of charging systems; and
a utility enterprise system configured to:
determine a demand condition for a utility grid; and
based on the demand condition, issue a demand response signal to the plurality of charging systems,
wherein each of the plurality of charging systems includes:
a utility power connection configured to receive power from the utility grid;
a charging connection configured to supply power to an electric vehicle charger;
a relay configured to control supply of power to the charging connection; and
a controller configured to receive the demand response signal and control the relay based on the demand response signal.

15. The system of claim 14, wherein each of the plurality of charging systems has a status as being opted in to or opted out of demand response, and wherein load control receivers having a status of being opted in to demand response reduce the quantity of power provided to the respective electric vehicle charger in response to the demand response signal.

16. The system of claim 15, wherein each of the plurality of charging systems is configured to receive a user input of a respective status as being opted in to or opted out of demand response.

17. The system of claim 14, further comprising a notification system configured to, based on the demand condition determined at the utility enterprise system, determine a charging opportunity, assign the charging opportunity to one or more users of the plurality of charging systems, and issue a notification to the one or more users.

18. The system of claim 17, wherein the notification system is configured to assign the charging opportunity to the one or more users based on weighted randomization, wherein the weighting is based on one or more characteristics of the user.

19. The system of claim 17, wherein the charging opportunity includes a beginning and an end of a low demand period, and charging stations associated with the one or more users are configured to perform charging between the beginning and the end of the low demand period.

20. The system of claim 19, wherein the charging stations associated with the one or more users are further configured to perform charging before the beginning of the low demand period or following the end of the low demand period.
